(19) United States
(12) Patent Application Publication
(10) Pub. No.: US 2014/0242561 A1
(43) Pub. Date: Aug. 28, 2014

(54) METHOD OF TREATING SPINAL PROBLEMS IN HUMANS

(71) Applicant: Anna Dmitrievna Vladimirova, Moscow (RU)

(72) Inventor: Anna Dmitrievna Vladimirova, Moscow (RU)

(21) Appl. No.: 14/190,196

(22) Filed: Feb. 26, 2014

(30) Foreign Application Priority Data
Feb. 28, 2013 (EA) 201300195

(51) Int. Cl. G09B 19/00

(52) U.S. Cl. CPC G09B 19/00
USPC 434/247

(57) ABSTRACT

A medical non-invasive treatment of humans for treating spinal disorders, such as spinal curvature, osteochondrosis, scoliosis, and other related problems. The treatment includes formation of stable synaptic connections in the patient's mind by means of forming patient's conditional reflexes to the ideal way of performing an exercise, as shown by the expert. The treatment leads to formation of correct posture through the process comprising: patient being treated while standing, sitting or lying; a special film running on the screen, which shows an expert, who ideally performs exercises, and accentuates attention on certain parts of the spine by highlighting them and playing sounds of varying volume; the same parts of the patient's spine are being touched by the coach, a partner or the patient themselves simultaneously with the video.

### CROSS-REFERENCE TO RELATED APPLICATIONS

This application claims priority to Eurasian Patent Application No. 201300195, filed on Feb. 28, 2013, which is incorporated by reference herein in its entirety.

### BACKGROUND OF THE INVENTION

1. Field of the Invention

The present invention relates to medical treatment, and, in particular, to non-invasive treatment of humans. It can be used to treat spinal disorders, such as spinal curvature, osteochondrosis, scoliosis, and other related problems.

2. Background of the Related Art

A conventional method of preventing slouch, spinal curvature, chest distortion and cervical spine traumas in people working with computers employs a minor element placed above the monitor that shows the person their reflection on the monitor level (see RU No. 2006130199). Thus, the person has an opportunity to check constantly the position of their head and correct their posture, if needed, without the need to stop working.

The problem of the conventional method is that the posture check is performed by the patient themselves and not by specially educated medical staff.

Another known method of treating humans involves changing their posture and formation of a conscious skill to control muscles keeping the spine upright (see RU No. 2300362).

The main problem of this method is that it can only be applied to active patients capable of performing strenuous physical activities, which should lead to the formation of the right image of the correct posture.

### SUMMARY OF THE INVENTION

Accordingly, the objective of the invention is to expand the possibilities of treatment with a new method, where the treatment consists of forming stable synaptic connections in the patient's mind by forming patient's conditional reflexes to the ideal way of performing an exercise, as shown by an expert.

Additional features and advantages of the invention will be set forth in the description that follows, and in part will be apparent from the description, or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### DETAILED DESCRIPTION OF THE PREFERRED EMBODIMENTS

Reference will now be made in detail to the preferred embodiments of the present invention, examples of which are illustrated in the accompanying drawings.

To achieve the objective, an exercise therapy expert chooses an exercise, taking into account its maximum effectiveness for the specific type of spinal disorder (e.g., slow bending and unbending of the torso). The exercise should be performed while the patient is relaxed, and his joints should be moving naturally (physiologically). An important part of the treatment is a movie (film) showing the ideal exercise. In order not to distract the patient with the actual appearance of the expert performing this exercise, and to make it easier for the patient to identify himself with the person on screen, the movie shows a semi-transparent model (i.e., about 50-75% transparent) of an average-built person bearing no obvious gender characteristics, with certain vertebrae being highlighted on its spine. In the beginning of the exercise, none of the vertebrae are highlighted. In one exemplary exercise, all thoracic (T) and all lumbar (L) vertebrae are used, i.e., T1-T12 and L1-L5. In the first stage, vertebrae are highlighted one by one and do not move (i.e., T1, T2, T3 . . . T12, L1, L2, L3, L4, L5). Simultaneously with highlighting, the patient by himself or his coach touch an average area of projection of vertebrae on the body of the patient on the front side or at the spine. It is easy to find T1—it just under the neck after the most prominent point on the neck (C7 is the prominent one). Thus, it is 17 points in sequence. Highlighting on the screen is from top to bottom and simultaneously the patient is touched in a direct line on the body. In particular with scoliosis, there is no need to look for a real location of the vertebrae in the body, but “pretend” that the vertebrae is under central line of body. During the film, the model performs the ideal exercise, while parts of its body (corresponding to specific vertebrae to be bent) are being rhythmically highlighted in a sequence, and the highlights are accompanied by sounds of varying volume. The sound generally resembles sea wave patterns or ocean wave patterns, initially starting softly, and becoming louder over time. The first part of the movie is about 1 minute. The second part has three repeated sequences of about 2 minutes each.

The model film is created as follows procedure:

An expert, experienced in performing the chosen exercise, executes it in a studio wearing a special costume with optical markers. The exercise is filmed by motion capturing camera(s) (see http:**en.wikipedia.org/wiki/Motion_capture). This creates a set of marker points representing the movements of the expert while performing the exercise, which is subsequently used to model the movements of spine and other invisible parts of the organism (bones, joints, ligaments, organs), based on anatomical and biomechanical data. The digital model is then enhanced to show clearly the ideal exercise (both anatomically and biomechanically).

Another part of the film is created, but the model shown on the screen does not move, while parts of its body corresponding to specific vertebrae are being rhythmically highlighted in a sequence, from the top to the bottom, while the highlights are accompanied by sounds of varying volume. When a model's vertebra is highlighted, the same part of the patient's spine is being touched by the coach, a partner or the patient themselves.

This additional part should be presented before the main part with the exercise;

both parts should be shown, preferably, three times in a row. Transition between the parts of the film should be smooth in terms of visual and audio perception, in order not to break the patients immersion and identification with the model.

The screen size should be between 0.7-2.5 m; the method also uses a pointer, which should be 0.3-0.4 m long.

In one embodiment, the method is implemented as follows:

The patient is seated facing the screen, so that the screen is in front of them thus keeping their oculomotoric muscles relaxed, and the patient's back is not reclined onto anything. Bed-ridden patients can be treated while lying, preferably, on their side. Eyes should be relaxed as if the patient looks “through” the screen.

The film starts. The first half of the film contains semi-transparent images of an immobile human model with a schematic view of the spine inside it (namely, thoracic spine, lumbar spine and sacrum). Parts of the model's body corresponding to specific vertebrae are being highlighted in sequence, accompanied by changes in sound volume, starting with the first thoracic vertebra and going down. Each time, when the next vertebra is highlighted, the coach, an assistant, a partner or the patient themselves touch the patient's spine with the pointer, so that the part of the spine touched coincides with that highlighted on the screen. The principle is to show the patient a video of “ideal” movement with several stages. First—association, when there is no movement, only highlighting. If the vertebrae are touched simultaneously with highlighting, there will be an illusion in the brain that the video is part of the body. The next stage is movement on the video and no movement in the real world. During this stage, neurons study how to make this movement in a new way, and with the help of the illusion created on the first stage, the learning process happens way much faster. The touch of each vertebra is about 2 seconds, with a pause of about 1-1.5 seconds between the touches. This part of the film should be shown, preferably, three times in a row. After this stage of the treatment, the patient should identify themselves with the model on the screen at the neurological level (i.e., an association illusion).

The second half of the film shows the model performing the exercise, where various vertebrae of the model's spine are highlighted in sequence and then bent. When this part is shown, the patient should remain relaxed and immobile, still looking ahead. Meanwhile, the coach, an assistant, a partner or the patient themselves touch the patient's spine with the pointer, so that the part of the spine touched coincides with the part highlighted on the screen. The patient can use a special stick or curved pointer to touch his own vertebrae, or, optionally, can touch the front of the body as well. Another way of carrying out this stage is to let the patient stand still while watching the model perform the exercise. This part of the film should be shown, preferably, three times in a row.

The method is based on the effect, wherein the mirror neurons are stimulated by watching movements executed by other people or animals with similar organization of the body (see V. Kosonogov, Mirror neurons: short review, Rostov-on-Don publishing, p. 24, 2009). One of the modem theories proposes that scoliosis is caused by malfunctioning of small rotator muscles, which enable twisting of the spine. These muscles cannot be controlled separately, though they are similar to cross-striated ones. According to studies by Vilayanur Ramachandran (see V. S. Ramachandran, Plasticity and functional recovery in neurology, Clinical medicine, 5(4), 368-73 (2005)), a mammalian brain is able to change its cell structure and way of functioning significantly, depending on its activity and stimulation of various areas. When some part of the body is stimulated, the number of neurons controlling it grows. It has been found that sensory stimulation causes reaction in the nervous system, so that neurons sort out the growth factors, and motion neurons in the cortex are activated by illusory movements (see Naito E. and Ehrsson H H., Kinesthetic illusory wrist movements activate motor-related areas that are active during movement execution, Neuroreport 12:1-5 (2001)).

### EXAMPLE

Patient: Vladimir, 24, scoliosis type 2.

The expert chose the exercise, which is common for treating spinal disorders: torso is being bent forward and then slowly unbent.

Then the film showing the ideal execution of this exercise was created. An expert, experienced in performing the exercise, executed it in the studio wearing a special costume with optical markers. The exercise was filmed by motion capturing cameras (see http://en.wikipedia.org/wiki/Motion_capture). This created a set of marker points representing the movements of the expert while performing the exercise, which was subsequently used to model the movements of spine and other invisible parts of the organism (bones, joints, ligaments, organs), based on anatomical and biomechanical data. This digital model was enhanced to show clearly the ideal exercise (both anatomically and biomechanically).

In order not to distract the patient with the actual appearance of the expert performing this exercise and make it easier for him to identify himself with the person on screen, the movie showed a semi-transparent model of an average-built person bearing no evident gender characteristics, with certain vertebrae being highlighted on its spine.

During the film, the model performed the ideal exercise, while parts of its body corresponding to specific vertebrae to be bent were being rhythmically highlighted in a sequence and the highlights were accompanied by sounds of varying volume. Another part of the film showed the model standing still, while parts of its body corresponding to specific vertebrae were being rhythmically highlighted in a sequence, from the top to the bottom, while the highlights were accompanied by sounds of varying volume.

This extra part was presented three times before the main part with the exercise, which was also shown three times. The patient was seated facing the 0.7 m screen. The screen was immediately in front of the patient, thus keeping his oculomotoric muscles relaxed, and his back was not reclined onto anything. His eyes were relaxed as if he looked “through” the screen. The coach was present during the procedure. He used a 0.4 m-long pointer.

The film started. The first part of the film containing semi-transparent images of an immobile human model with schematic view of the spine inside it (namely, thoracic spine, lumbar spine and sacrum) was shown three times. Parts of the model's body corresponding to specific vertebrae were being highlighted in sequence, accompanied by changes in sound volume, starting with the first thoracic vertebra and going down. Each time, when the next vertebra was highlighted, the coach touched the same part of the patient's spine with the pointer. After this stage of the treatment, the patient could identify himself with the model on the screen at the neurological level (i.e., the association illusion).

The second part of the film showed the model performing the exercise, wherein various vertebrae of the model's spine were highlighted in sequence and then bent. During this part the patient remained relaxed and immobile, still looking ahead. Meanwhile, the coach touched the patient's spine with the pointer, so that the part of the spine touched coincided with that highlighted on the screen. This part of the film was shown three times. The whole procedure had been carried out twice a day.

After two weeks of daily exercises, the progress was obvious. After nine months of daily exercises, the patient's brain formed new synaptic connections, which led to the full correction of his posture. The effect of the method has lasted for at least two years after the treatment was finished.

Having thus described a preferred embodiment, it should be apparent to those skilled in the art that certain advantages of the described method and apparatus have been achieved.

It should also be appreciated that various modifications, adaptations and alternative embodiments thereof may be made within the scope and spirit of the present invention. The invention is further defined by the following claims.

What is claimed is:

1. A method of treatment of spinal problems and formation of correct posture, the method comprising:
wherein the patient is being treated while standing, sitting or lying; showing a film to a patient, wherein the film shows an expert, who performs spine exercises, and
wherein the expert focuses attention of the patient on specific parts of the spine by highlighting them, and
playing sounds or varying volume;
simultaneously with showing the film, touching parts of the spine that are highlighted in the film.

2. The method of claim 1, wherein the film shows a semi-transparent model of an average-built person with no evident gender characteristics, and with certain vertebrae being highlighted on its spine.

3. The method of claim 2, wherein the film includes a first part and a second part, wherein during the first part, the model does not move, but portions of the model's body corresponding to specific vertebrae are rhythmically highlighted in sequence, from top to bottom, while the highlights are accompanied by sounds of varying volume, and
wherein during the second part, the model performs an ideal exercise, while vertebrae undergoing the maximum muscle stress are being highlighted in sequence before they are bent.

4. The method of claim 3, wherein the film is made in a studio by a human wearing a costume with optical markers, whose movements are filmed by motion capturing camera(s), and wherein a set of marker points is subsequently used to model movements of spine, based on anatomical and biomechanical data.

5. The method of claim 3, wherein the screen is placed immediately in front of the patient, thereby keeping the patient's oculomotoric muscles relaxed, and wherein the patient's back is not reclined.

6. The method of claim 3, further comprising touching the patient's back along a central body line in places corresponding to normal vertebrae projections as prompted by highlights and sounds in the film.

7. The method of claim 6, wherein the patient's spine is being touched only during the first part of the film.

8. The method of claim 1, wherein the exercise is performed while the patient is relaxed, and the patient's joints are moving in physiologically natural manner.
